(19) United States
(12) Patent Application Publication
(10) Pub. No.: US 2025/0125407 A1
(43) Pub. Date: Apr. 17, 2025

(54) HIGH-PURITY ARGYRODITE-PHASE SULFIDE SOLID ELECTROLYTE AND PREPARATION METHOD THEREOF

(71) Applicant: NINGBO INSTITUTE OF MATERIALS TECHNOLOGY AND ENGINEERING, CHINESE ACADEMY OF SCIENCES, Ningbo, Zhejiang (CN)

(72) Inventors: Xiayin Yao, Ningbo, Zhejiang (CN); Gaozhan Liu, Ningbo, Zhejiang (CN); Jing Yang, Ningbo, Zhejiang (CN)

(21) Appl. No.: 18/578,014

(22) PCT Filed: May 31, 2023
(86) PCT No.: PCT/CN2023/097287

§ 371 Date: Jan. 10, 2024

(30) Foreign Application Priority Data
Sep. 5, 2022 (CN) 202211077906.4

(51) Int. Cl. H01M 10/0562; C01B 25/14

(52) U.S. Cl. CPC H01M 10/0562; C01B 25/14; C01P 2002/72; C01P 2006/40; H01M 2300/008

(57) ABSTRACT

The invention belongs to the technical field of batteries, and relates to a high-purity argyrodite-phase sulfide solid electrolyte and a preparation method thereof. The high-purity argyrodite-phase sulfide solid electrolyte is of molecular formula I: L_{i6±i}P₁₋ₑEₑS_{5±i-g}G_{g}Cl₁₊ᵢ₊ₜTₜ formula I. In formula I, 0Si≤1, 0≤e≤1, 0≤g≤0.5, 0.2≤t≤1, E is one or more of Ge, Si, Sn and Sb, G is compound of Se and O, or O, and T is Br and/or I; and the high-purity argyrodite-phase sulfide solid electrolyte has a pure phase. The pure-phase electrolyte has a high ionic conductivity, good stability against air, good stability against organic solvents, and good stability against lithium.

### TECHNICAL FIELD

The invention belongs to the technical field of batteries, and relates to a high-purity argyrodite-phase sulfide solid electrolyte and a preparation method thereof.

### DESCRIPTION OF RELATED ART

Solid electrolytes are an important part of all-solid-state batteries, and argyrodite-phase sulfide solid electrolytes have a high room-temperature ionic conductivity and a low electronic conductivity, and also have good mechanical performance, which is beneficial to the formation of good solid-solid contact interfaces between electrodes/electrolytes in all-solid-state batteries. However, most existing argyrodite-phase sulfide solid electrolytes are impure in phase, and contain impurity phases such as raw materials or sintering intermediates, compromising the chemical stability of electrolytes and reaction products on electrolyte/electrode interfaces. In addition, a high-purity argyrodite-phase sulfide solid electrolyte is often prepared by increasing the ball-milling time of a precursor and the heat treatment time. It generally takes about one to two weeks, and the room-temperature ionic conductivity of the prepared high-purity argyrodite-phase sulfide solid electrolyte is low. Quick preparation of high-purity argyrodite-phase sulfide solid electrolytes and improvement of the room-temperature ionic conductivity are of great importance for optimizing the performance of electrolytes and all-solid-state batteries.

### BRIEF SUMMARY OF THE INVENTION

In view of the defects of argyrodite-phase sulfide solid electrolytes in the prior art, the invention provides a high-purity argyrodite-phase sulfide solid electrolyte which has a pure phase, and also provide a preparation method of the high-purity argyrodite-phase sulfide solid electrolyte.

In one aspect, the invention provides a high-purity argyrodite-phase sulfide solid electrolyte of molecular formula I:

L_{i6±i}P₁₋ₑEₑS_{5±i-g}G_{g}Cl_{1±i±t}Tₜ formula I;
In formula I, 0≤i<1, 0≤e<1, 0<g≤0.5, 0.2<<1, E is one or more of Ge, Si, Sn and Sb, G is compound of Se and O, or O, and T is Br and/or I;
The high-purity argyrodite-phase sulfide solid electrolyte has a pure phase, and is free of a raw material phase, and there is no impurity peak in an X-ray diffraction spectrogram of the high-purity argyrodite-phase sulfide solid electrolyte.

The frame of an argyrodite-phase crystal structure is constructed by a PS₄³⁻ tetrahedron, in which Li⁺ ions, halide ions (Cl⁻ ions, Br⁻ ions and I⁻ ions) and part of S²⁻ ions are regularly dispersed. Doped O preferentially replaces S in the PS₄³⁻ tetrahedron, and some P—S bonds turn into P—O bonds. Because the P—O bonds are shorter than the P—S bonds, the size of a PS₄³⁻ group will be decreased due to O-doping, leading to a change in the crystal structure. When the amount of O doped in Li₆PS₅Cl is excessive, the size of the PS₄³⁻ group will decreased greatly, resulting in shrinkage of the crystal structure. The free Li⁺ ions, S²⁻ ions and Cl ions will be forced out of the crystal structure and form impurity phases including Li₂S, LiCl and other components. In the invention, in order to avoid the formation of an impurity phase, the atomicity of G is defined as 0 kg≤0.5 to prevent excessive addition of O. Moreover, in order to ensure that the size of the crystal structure is not changed after O-doping, Br or I ions with a large radius are correspondingly doped on halogen sites, such that the large-sized halogen ions can compensate for a size reduction caused in case of a large doping amount of O, to support the frame of the crystal structure, and the free Li⁺ ions, S²⁻ ions and halide ions will not be forced out of the crystal structure, and thus will not form impurity phases.

Preferably, the room-temperature ionic conductivity of the high-purity argyrodite-phase sulfide solid electrolyte is 1×10⁻³-8×10⁻² S/cm. The room temperature herein is 15-35° C.

Preferably, the high-purity argyrodite-phase sulfide solid electrolyte has good stability against lithium.

Preferably, after being exposed to a dew-point temperature of −40° C. in a drying room for 4 hrs, the high-purity argyrodite-phase sulfide solid electrolyte has the ionic conductivity decreased by 15% or less.

Preferably, after being soaked in an organic solvent at room temperature for 2 hrs, the high-purity argyrodite-phase sulfide solid electrolyte has the ionic conductivity decreased by 20% or less.

Preferably, the organic solvent is one or more selected from a group consisting of ethylene carbonate, fluoroethylene carbonate, ethyl methyl carbonate, dimethyl carbonate, N-methylpyrrolidone, tetrahydrofuran, glycol dimethyl ether, anisole, 1,3-oxacyclopentane, methylbenzene, xylene, chlorobenzene, and n-heptane.

In another aspect, the invention provides a preparation method of a high-purity argyrodite-phase sulfide solid electrolyte, comprising:
(a) preparing a lithium sulfide material;
(b) weighing raw materials comprising the lithium sulfide material and an oxidant according to a molar ratio, and mixing the raw materials to obtain an electrolyte precursor; and
(c) performing annealing sintering on the precursor obtained in Step (b) to obtain a high-purity argyrodite-phase sulfide solid electrolyte.

Preferably, a method for preparing the lithium sulfide material comprises one or more of a ball-milling method, a carbothermic method, lithiation of a sulfur-containing chemical substance, sulfuration of lithium nano-particles, and inter-reaction between lithium-containing and sulfur-containing substances.

Preferably, the oxidant in Step (b) is one or more of Li₂O, P₂O₅, Li₃PO₄ and I₂. Under the oxidization effect of the added oxidant, the argyrodite-phase sulfide solid electrolyte obtains a high-purity phase.

Preferably, a method for mixing the raw material in Step (b) comprises one or more of manual grinding, mechanical stirring, mechanical oscillation, mechanical ball-milling, high-energy ball-milling, and roller-milling.

In a case where the method for mixing the raw materials in Step (b) is the high-energy ball-milling or the roller-milling, the ball-material ratio is (1-60): 1, the high-energy ball-milling or the roller-milling is carried out at a speed of 200-600 rpm for 4-24 hrs.

Preferably, in Step (c), the annealing sintering is performed at 400-600° C. for 1-48 hrs.

In another aspect, the invention provides an all-solid-state battery, comprising a positive pole, a negative pole, and the high-purity argyrodite-phase sulfide solid electrolyte.

Compared with the prior art, the invention has the following beneficial effects:

1. The argyrodite-phase sulfide solid electrolyte provided by the invention is pure in phase, and there is no impurity peak in the X-ray diffraction spectrogram of the argyrodite-phase sulfide solid electrolyte.

2. The high-purity argyrodite-phase sulfide solid electrolyte provided by the invention has a high ionic conductivity.

3. The high-purity argyrodite-phase sulfide solid electrolyte provided by the invention has good stability against air, good stability against organic solvents, and good stability against lithium;

4. In the invention, the raw materials comprising the lithium sulfide material and the oxidant are mixed for reaction, and under the action of the oxidant, the high-purity argyrodite-phase sulfide solid electrolyte is prepared.

5. The high-purity argyrodite-phase sulfide solid electrolyte provided by the invention can be applied to the all-solid-state battery and can effectively improve the performance of the battery.

### BRIEF DESCRIPTION OF THE SEVERAL VIEWS OF THE DRAWINGS

FIG. 1 illustrates an X-ray diffraction spectrogram of a Li₆PS_{4.8}O_{0.2}Cl_{0.5}Br_{0.5} electrolyte in Embodiment 1;

FIG. 2 is a room-temperature AC test impedance diagram of the Li₆PS_{4.8}O_{0.2}Cl_{0.5}Br_{0.5} electrolyte in Embodiment 1;

FIG. 3 illustrates the stability of the Li₆PS_{4.8}O_{0.2}Cl_{0.5}Br_{0.5} electrolyte against lithium in Embodiment 1;

FIG. 4 illustrates a constant-current charge-discharge curve chart of a Li/Li₆PS_{4.8}O_{0.2}Cl_{0.5}Br_{0.5}/NCM battery;

FIG. 5 is a cycle diagram of the Li/Li₆PS_{4.8}O_{0.2}Cl_{0.5}Br_{0.5}/NCM battery;

FIG. 6 is an X-ray diffraction spectrogram of a Li₆PS₅Cl_{0.5}Br_{0.5} electrolyte in Comparative Example 1;

FIG. 7 is a room-temperature AC test impedance diagram of the Li₆PS₅Cl_{0.5}Br_{0.5} electrolyte in Comparative Example 1;

FIG. 8 illustrates the stability of the Li₆PS₅Cl_{0.5}Br_{0.5} electrolyte against lithium in Comparative Example 1.

### DETAILED DESCRIPTION OF THE INVENTION

The technical solutions of the invention will be further described below in conjunction with specific embodiments and accompanying drawings. It should be understood that the specific embodiments in the following description are merely used to help understand the invention, and are not intended to limit the invention. Unless otherwise specifically stated, raw materials used in the embodiments of the invention are all common raw materials in the art, and the methods used in the embodiments are all conventional methods in the art.

### Embodiment 1

A high-purity argyrodite-phase sulfide solid electrolyte in this embodiment has a molecular formula: Li₆PS_{4.8}O_{0.2}Cl_{0.5}Br_{0.5}, and is obtained through the following preparation method:
(a) A lithium sulfide material was prepared by inter-reaction between lithium-containing and sulfur-containing substances: lithium and elemental sulfur were dissolved in diethyl ether respectively according to a mass ratio of 2.1:1, mixed, and then distillated under reduced pressure to obtain Li₂S;
(b) Li₂S, P₂S₅, P₂O₅, LiCl and LiBr were weighed according to a molar ratio, poured into an agate mortar, and then manually ground for 30 min to obtain an electrolyte precursor; and
(c) The electrolyte precursor was sintered in vacuum at 550° C. for 4 hrs to obtain the Li₆PS_{4.8}O_{0.2}Cl_{0.5}Br_{0.5} electrolyte.

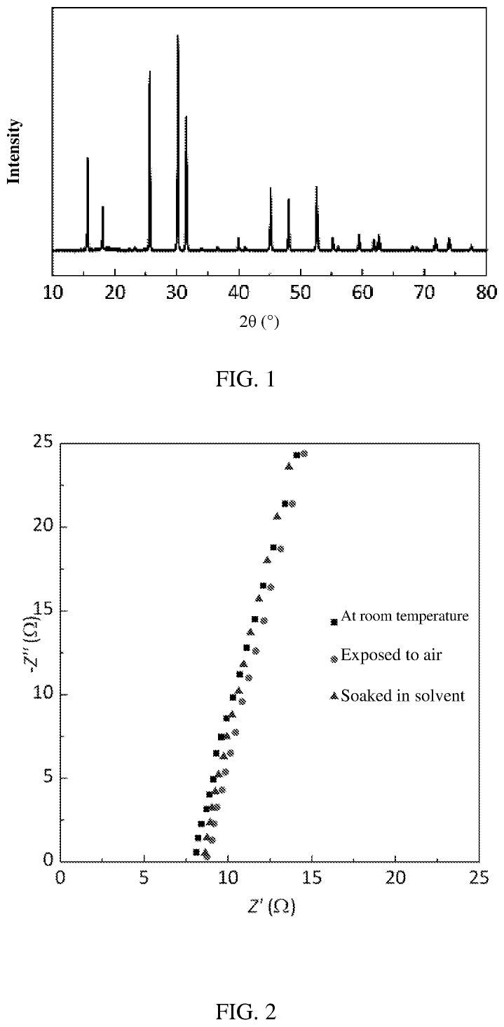

The Li₆PS_{4.8}O_{0.2}Cl_{0.5}Br_{0.5} electrolyte has a pure argyrodite phase, and is free of raw material phases. As can be seen from FIG. 1 which illustrates an X-ray diffraction spectrogram of the Li₆PS_{4.8}O_{0.2}Cl_{0.5}Br_{0.5} electrolyte, the electrolyte does not have any impurity peak.

An original room-temperature AC test impedance diagram of the Li₆PS_{4.8}O_{0.2}Cl_{0.5}Br_{0.5} electrolyte is shown in FIG. 2. The room-temperature ionic conductivity of the Li₆PS_{4.8}O_{0.2}Cl_{0.5}Br_{0.5} electrolyte was 16 mS/cm, as shown in Table 1.

After the Li₆PS_{4.8}O_{0.2}Cl_{0.5}Br_{0.5} electrolyte was soaked in an anisole solvent at room temperature for 2 hrs and then dried, the room-temperature AC test impedance diagram of the Li₆PS_{4.8}O_{0.2}Cl_{0.5}Br_{0.5} electrolyte is shown in FIG. 2, and the ionic conductivity of the Li₆PS_{4.8}O_{0.2}Cl_{0.5}Br_{0.5} electrolyte was 14.73 mS/cm, as shown in Table 1. After the Li₆PS_{4.8}O_{0.2}Cl_{0.5}Br_{0.5} electrolyte was exposed to the dew-point temperature of −40° C. in a drying room for 4 hrs, the room-temperature AC test impedance diagram of the Li₆PS_{4.8}O_{0.2}Cl_{0.5}Br_{0.5} electrolyte is shown in FIG. 2, and the room-temperature ionic conductivity of the Li₆PS_{4.8}O_{0.2}Cl_{0.5}Br_{0.5} electrolyte was 14.56 mS/cm, as shown in Table 1.

TABLE 1
Room-temperature ionic conductivity of Li₆PS_{4.8}O_{0.2}Cl_{0.5}Br_{0.5}
electrolyte

| Treatment | Thickness | | | Conductivity |
|---|---|---|---|---|
| method | (cm) | Area (cm²) | Impedance (Ω) | (mS/cm) |
| At Room | 0.1 | 0.785 | 7.96 | 16 |
| temperature | | | | |
| Exposed to air | 0.1 | 0.785 | 8.75 | 14.56 |
| Soaked in | 0.099 | 0.785 | 8.56 | 14.73 |
| solvent at room | | | | |
| temperature | | | | |

To further study the stability of the prepared Li₆PS_{4.8}O_{0.2}Cl_{0.5}Br_{0.5} electrolyte against lithium electrodes to explore the feasibility of using lithium electrodes as negative poles, a constant-current charge-discharge test was carried out on a symmetric battery assembled from the electrolyte and metal lithium, and test results are shown in FIG. 3. The test current density for the Li/Li₆PS_{4.8}O_{0.2}Cl_{0.5}Br_{0.5}/Li symmetric battery was 1 mA/cm², the single charge-discharge time was 1 h, and the test capacity density was 1 mAh/cm². Test results indicate that the Li/Li₆PS_{4.8}O_{0.2}Cl_{0.5}Br_{0.5}/Li symmetric battery can be cycled for 12,000 h at the current density of 1 mA/cm², and the polarization voltage is hardly changed, indicating that the Li₆PS_{4.8}O_{0.2}Cl_{0.5}Br_{0.5} electrolyte has good stability against lithium.

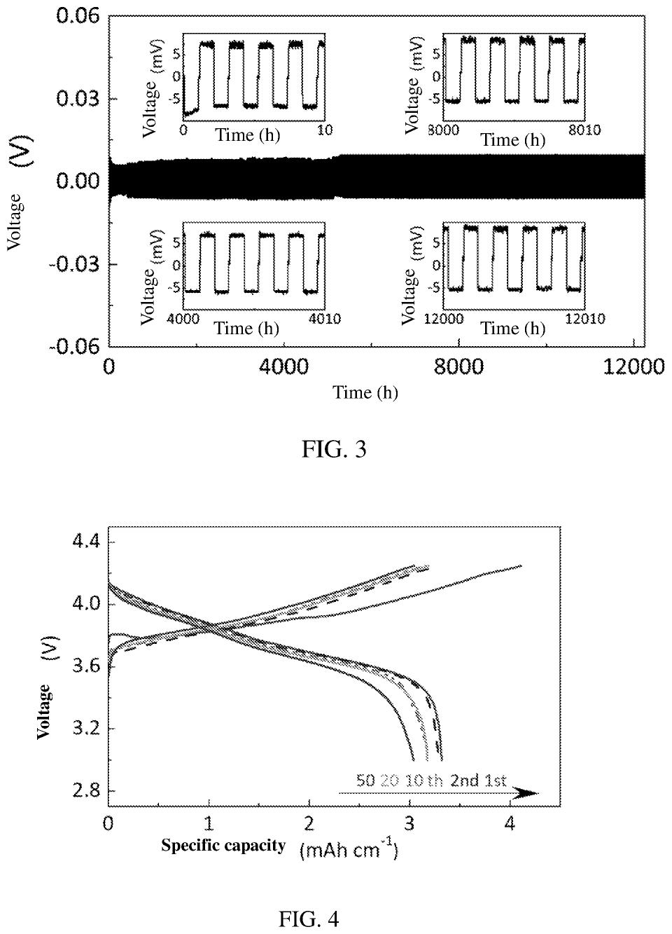

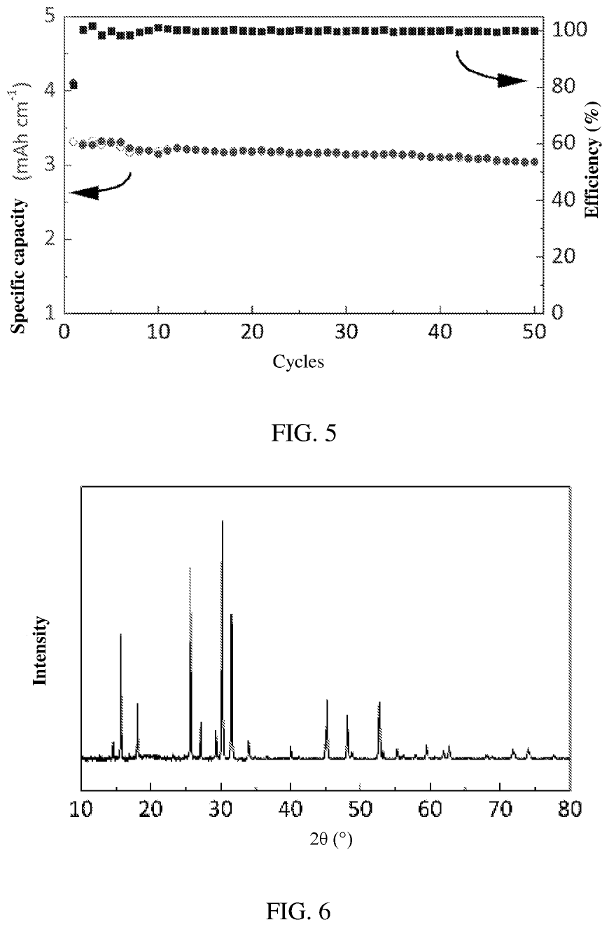

A charge-discharge test was carried out on an all-solid-state primary lithium battery assembled using lithium as a negative pole and LiNi_{0.8}Co_{0.1}Mn_{0.1}O₂ (NCM) as a positive pole. FIG. 4 illustrates a constant-current charge-discharge curve chart of the Li/Li₆PS_{4.8}O_{0.2}Cl_{0.5}Br_{0.5}/NCM battery, and FIG. 5 illustrates a cycle diagram of the Li/Li₆PS_{4.8}O_{0.2}Cl_{0.5}Br_{0.5}/NCM battery. By testing the battery under 0.5 C, the initial specific discharge capacity was 3.31 mAh/cm² and the initial coulombic efficiency was 80.7%. After 50 cycles, the specific discharge capacity was 3.04 mAh/cm².

### Embodiment 2

A high-purity argyrodite-phase sulfide solid electrolyte in this embodiment has a molecular formula: Li_{5.4}PS_{4.3}O_{0.1}Cl_{1.4}I_{0.2}, and is obtained through the following preparation method:
(a) A lithium sulfide material was prepared by a ball-milling method and inter-reaction between lithium-containing and sulfur-containing substances: lithium and elemental sulfur were dissolved in tetrahydrofuran respectively according to a mass ratio of 2.2:1, ball-milled and mixed at 200 r/min for 24 hrs, and then distillated under reduced pressure to obtain Li₂S;
(b) Li₂S, Li₃PO₄, LiCl and I₂ were weighed according to a molar ratio, poured into a stirring tank to be mechanically stirred at 300 r/min for 1 h, and then poured into a high-energy ball-milling tank according to a ball-material ratio of 30:1 to be subjected to high-energy ball-milling at 300 rpm for 24 hrs to obtain an electrolyte precursor; and
(c) The electrolyte precursor was sintered in vacuum at 540° C. for 12 hrs to obtain the Li_{5.4}PS_{4.3}O_{0.1}Cl_{1.4}I_{0.2} electrolyte.

The Li_{5.4}PS_{4.3}O_{0.1}Cl_{1.4}I_{0.2} electrolyte has a pure argyrodite phase, and is free of raw material phases.

The original room-temperature ionic conductivity of the Li_{5.4}PS_{4.3}O_{0.1}Cl_{1.4}I_{0.2} electrolyte was 10.5 mS/cm.

After the Li_{5.4}PS_{4.3}O_{0.1}Cl_{1.4}I_{0.2} electrolyte was soaked in an anisole and tetrahydrofuran solvent (the volume ratio of anisole and tetrahydrofuran was 1:2) at room temperature for 2 hrs and then dried, the room-temperature ionic conductivity of the Li_{5.4}PS_{4.3}O_{0.1}Cl_{1.4}I_{0.2} electrolyte was 9.03 mS/cm.

After the Li_{5.4}PS_{4.3}O_{0.1}Cl_{1.4}I_{0.2} electrolyte was exposed to the dew-point temperature of −40° C. in a drying room for 4 hrs, the room-temperature ionic conductivity of the Li_{5.4}PS_{4.3}O_{0.1}Cl_{1.4}I_{0.2} electrolyte was 9.77 mS/cm.

To further study the stability of the prepared Li_{5.4}PS_{4.3}O_{0.1}Cl_{1.4}I_{0.2} electrolyte against lithium electrodes to explore the feasibility of using lithium electrodes as negative poles, a constant-current charge-discharge test was carried out on a symmetric battery assembled from the electrolyte and metal lithium. The test current density for the Li/Li_{5.4}PS_{4.3}O_{0.1}Cl_{1.4}I_{0.2}/Li symmetric battery was 2 mA/cm², the single charge-discharge time was 1 h, and the test capacity density was 2 mAh/cm². Test results indicate that the Li/Li_{5.4}PS_{4.3}O_{0.1}Cl_{1.4}I_{0.2}/Li symmetric battery can be cycled for 500 times at the current density of 2 mA/cm², and the polarization voltage is hardly changed, indicating that the Li_{5.4}PS_{4.3}O_{0.1}Cl_{1.4}I_{0.2} electrolyte has good stability against lithium.

A charge-discharge test was carried out on an all-solid-state primary lithium battery assembled using metal lithium as a negative pole and FeS₂ as a positive pole, at 2 mA/cm². After 500 cycles, the specific discharge capacity was 2.21 mAh/cm².

### Embodiment 3

A high-purity argyrodite-phase sulfide solid electrolyte prepared in this embodiment has a molecular formula: Li_{5.4}PS_{4.2}O_{0.2}Cl_{1.1}Br_{0.5}, and is obtained through the following preparation method:
(a) A lithium sulfide material was prepared: dry sulfur powder and lithium hydride powder were mixed according to a mass ratio of 1:1, and then added into a ball-milling tank to be ball-milled at room temperature, 100 r/min for 24 hrs to obtain Li₂S;
(b) Li₂S, P₂O₅, LiCl and LiBr were weighed according to a molar ratio, and then poured into a stirring tank to be mechanically stirred at 400 r/min for 8 hrs to obtain an electrolyte precursor; and
(c) The electrolyte precursor was sintered in vacuum at 580° C. for 24 hrs to obtain a Li_{5.4}PS_{4.2}O_{0.2}Cl_{0.5}Br_{0.5} electrolyte.

The Li_{5.4}PS_{4.2}O_{0.2}Cl_{0.5}Br_{0.5} electrolyte has a pure argyrodite phase, and is free of raw material phases.

The original room-temperature ionic conductivity of the Li_{5.4}PS_{4.2}O_{0.2}Cl_{0.5}Br_{0.5} electrolyte was 19 mS/cm.

After the Li_{5.4}PS_{4.2}O_{0.2}Cl_{0.5}Br_{0.5} electrolyte was soaked in a solvent composed of dimethyl carbonate and fluoroethylene carbonate (the volume ratio of dimethyl carbonate to fluoroethylene carbonate was 4:1) at room temperature for 2 hrs and then dried, the room-temperature ionic conductivity of the Li_{5.4}PS_{4.2}O_{0.2}Cl_{0.5}Br_{0.5} electrolyte was 16.72 mS/cm.

After the Li_{5.4}PS_{4.2}O_{0.2}Cl_{0.5}Br_{0.5} electrolyte was exposed to the dew-point temperature of −40° C. in a drying room for 4 hrs, the room-temperature ionic conductivity of the Li_{5.4}PS_{4.2}O_{0.2}Cl_{0.5}Br_{0.5} electrolyte was 17.37 mS/cm.

To further study the stability of the prepared Li_{5.4}PS_{4.2}O_{0.2}Cl_{0.5}Br_{0.5} electrolyte against lithium electrodes to explore the feasibility of using lithium electrodes as negative poles, a constant-current charge-discharge test was carried out on a symmetric battery assembled from the electrolyte and metal lithium. The test current density for the Li/Li_{5.4}PS_{4.2}O_{0.2}Cl_{0.5}Br_{0.5}/Li symmetric battery was 5 mA/cm², the single charge-discharge time was 1 h, and the test capacity density was 5 mAh/cm². Test results indicate that the Li/Li_{5.4}PS_{4.2}O_{0.2}Cl_{0.5}Br_{0.5}/Li symmetric battery can be cycled for 1,000 times at the current density of 5 mA/cm², and the polarization voltage is hardly changed, indicating that the Li_{5.4}PS_{4.2}O_{0.2}Cl_{0.5}Br_{0.5} electrolyte has good stability against lithium.

A charge-discharge test was carried out on an all-solid-state primary lithium battery assembled using manganese-boron alloy as a negative pole and NCM as a positive pole, at 5 mA/cm². After 1,000 cycles, the specific discharge capacity was 5.71 mAh/cm².

### Embodiment 4

A high-purity argyrodite-phase sulfide solid electrolyte in this embodiment has a molecular formula: Li₆PS_{4.7}O_{0.3}Cl_{0.4}Br_{0.4}I_{0.2}, and is obtained through the following preparation method:
(a) A lithium sulfide material was prepared by sulfurating lithium nano-particles: the lithium nano-particles were dispersed in a tetrahydrofuran-n-hexane medium, and a mixture of hydrogen sulfide and argon was introduced to react with the lithium nano-particles for 24 hrs to obtain Li₂S;
(b) Li₂S, P₂O₅, LiCl, LiBr and Lil were weighed according to a molar ratio, poured into mortar to be ground, and then poured into a roller-milling tank according to a ball-material ratio of 5:1 to be subjected to roller-milling at 200 rpm for 24 hrs to obtain an electrolyte precursor;
(c) The electrolyte precursor was sintered in vacuum at 420° C. for 48 hrs to obtain the Li₆PS_{4.7}O_{0.3}Cl_{0.4}Br_{0.4}I_{0.2} electrolyte.

The Li₆PS_{4.7}O_{0.3}Cl_{0.4}Br_{0.4}I_{0.2} electrolyte has a pure argyrodite phase, and is free of raw material phases.

The original room-temperature ionic conductivity of the Li₆PS_{4.7}O_{0.3}Cl_{0.4}Br_{0.4}I_{0.2} electrolyte was 25 mS/cm.

After the Li₆PS_{4.7}O_{0.3}Cl_{0.4}Br_{0.4}I_{0.2} electrolyte was soaked in a fluoroethylene carbonate solvent at room temperature for 2 hrs and then dried, the room-temperature ionic conductivity of the Li₆PS_{4.7}O_{0.3}Cl_{0.4}Br_{0.4}I_{0.2} electrolyte was 20.25 mS/cm.

After the Li₆PS_{4.7}O_{0.3}Cl_{0.4}Br_{0.4}I_{0.2} electrolyte was exposed to the dew-point temperature of −40° C. in a drying room for 4 hrs, the room-temperature ionic conductivity of the Li₆PS_{4.7}O_{0.3}Cl_{0.4}Br_{0.4}I_{0.2} electrolyte was 24 mS/cm.

To further study the stability of the prepared Li₆PS_{4.7}O_{0.3}Cl_{0.4}Br_{0.4}I_{0.2} electrolyte against lithium electrodes to explore the feasibility of using lithium electrodes as negative poles, a constant-current charge-discharge test was carried out on a symmetric battery assembled from the electrolyte and metal lithium. The test current density for the Li/Li₆PS_{4.7}O_{0.3}Cl_{0.4}Br_{0.4}I_{0.2}/Li symmetric battery was 15 mA/cm², the single charge-discharge time was 1 h, and the test capacity density was 15 mAh/cm². Test results indicate that the Li/Li₆PS_{4.7}O_{0.3}Cl_{0.4}Br_{0.4}I_{0.2}/Li symmetric battery can be cycled for 1,000 times at the current density of 15 mA/cm², and the polarization voltage is hardly changed, indicating that the Li₆PS_{4.7}O_{0.3}Cl_{0.4}Br_{0.4}I_{0.2} electrolyte has good stability against lithium.

A charge-discharge test was carried out on an all-solid-state primary lithium battery assembled using lithium-indium alloy as a negative pole and LFP as a positive pole, at 15 mA/cm². After 1,000 cycles, the specific discharge capacity was 16.3 mAh/cm².

### Comparative Example 1

An electrolyte in Comparative Example 1 has a molecular formula: Li₆PS₅Cl_{0.5}Br_{0.5}, and is obtained through the following method:
(a) A lithium sulfide material was prepared by inter-reaction between lithium-containing and sulfur-containing substances: lithium and elemental sulfur were dissolved in diethyl ether respectively according to a mass ratio of 2.1:1, mixed, and then distillated under reduced pressure to obtain Li₂S;
(b) Li₂S, P₂S₅, P₂O₅, LiCl and LiBr were weighed according to a molar ratio, poured into an agate mortar, and then manually ground for 30 min to obtain an electrolyte precursor; and
(c) The electrolyte precursor was sintered in vacuum at 550° C. for 4 hrs to obtain the Li₆PS₅Cl_{0.5}Br_{0.5} electrolyte.

The Li₆PS₅Cl_{0.5}Br_{0.5} electrolyte has an argyrodite phase, and contains impurity phases, and as can be seen from FIG. 6 which illustrates an X-ray diffraction spectrogram of the Li₆PS₅Cl_{0.5}Br_{0.5} electrolyte, the electrolyte has a Li₂S impurity peak.

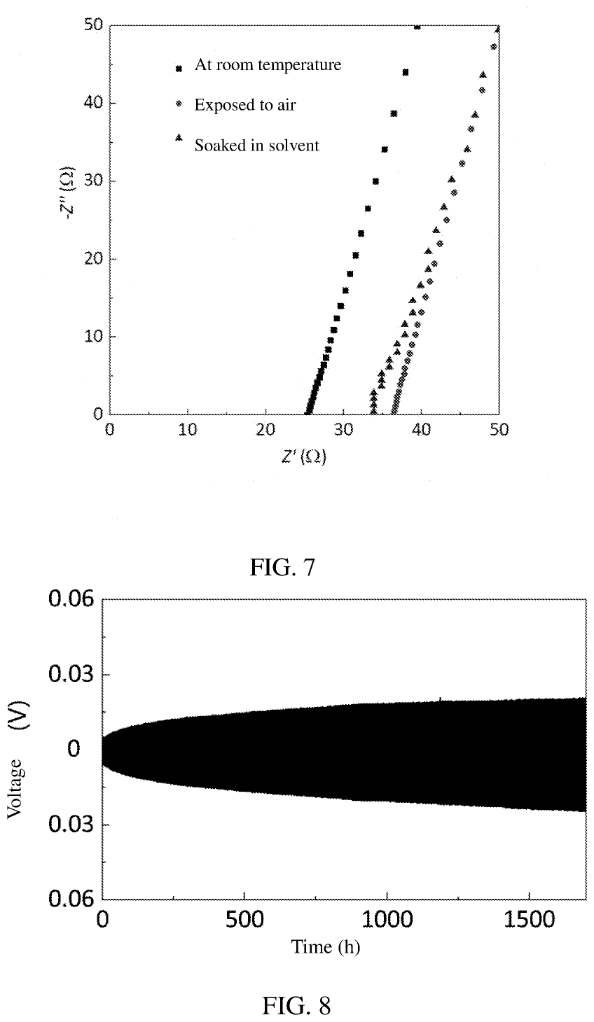

An original room-temperature AC test impedance diagram of the Li₆PS₅Cl_{0.5}Br_{0.5} electrolyte is shown in FIG. 7. The room-temperature ionic conductivity of the Li₆PS₅Cl_{0.5}Br_{0.5} electrolyte was 5 mS/cm, as shown in Table 2.

After the Li₆PS₅Cl_{0.5}Br_{0.5} electrolyte was soaked in an anisole solvent at room temperature for 2 hrs and then dried, the room-temperature AC test impedance diagram of the Li₆PS₅Cl_{0.5}Br_{0.5} electrolyte is shown in FIG. 7, and the conductivity of the Li₆PS₅Cl_{0.5}Br_{0.5} electrolyte was 3.75 mS/cm, as shown in Table 2.

After the Li₆PS₅Cl_{0.5}Br_{0.5} electrolyte was exposed to the dew-point temperature of −40° C. in a drying room for 4 hrs, the room-temperature AC test impedance diagram of the Li₆PS₅Cl_{0.5}Br_{0.5} electrolyte is shown in FIG. 7, and the room-temperature ionic conductivity of the Li₆PS₅Cl_{0.5}Br_{0.5} electrolyte was 3.5 mS/cm, as shown in Table 2.

TABLE 2
Room-temperature ionic conductivity of Li₆PS₅Cl_{0.5}Br_{0.5} electrolyte

| | Thickness | | Impedance | Conductivity |
|---|---|---|---|---|
| Treatment method | (cm) | Area (cm²) | (Ω) | (mS/cm) |
| At Room | 0.1 | 0.785 | 25.48 | 5.0 |
| temperature | | | | |
| Exposed to air | 0.1 | 0.785 | 36.40 | 3.5 |
| Soaked in solvent | 0.1 | 0.785 | 33.97 | 3.75 |
| at room | | | | |
| temperature | | | | |

To further study the stability of the prepared Li₆PS₅Cl_{0.5}Br_{0.5} electrolyte against lithium electrodes to explore the feasibility of using lithium electrodes as negative poles, a constant-current charge-discharge test was carried out on a symmetric battery assembled from the electrolyte and metal lithium, and test results are shown in FIG. 8. The test current density for the Li/Li₆PS₅Cl_{0.5}Br_{0.5}/Li symmetric battery was 0.1 mA/cm², the single charge-discharge time was 1 h, and the test capacity density was 0.1 mAh/cm². Test results indicate that the Li/Li₆PS₅Cl_{0.5}Br_{0.5}/Li symmetric battery can be cycled for 1,700 hrs at the current density of 0.1 mA/cm², and the polarization voltage is increased obviously, indicating that the Li₆PS₅Cl_{0.5}Br_{0.5} electrolyte has poor stability against lithium.

### Comparative Example 2

An electrolyte in Comparative Example 1 has a molecular formula: Li₆PS_{4.4}O_{0.6}Cl_{0.5}Br_{0.5}, and is obtained through the following preparation method:
(a) A lithium sulfide material was prepared by inter-reaction between lithium-containing and sulfur-containing substances: lithium and elemental sulfur were dissolved in diethyl ether respectively according to a mass ratio of 2.1:1, mixed, and then distillated under reduced pressure to obtain Li₂S;
(b) Li₂S, P₂S₅, P₂O₅ and LiCl were weighed according to a molar ratio, poured into an agate mortar, and then manually ground for 30 min to obtain an electrolyte precursor; and
(c) The electrolyte precursor was sintered in vacuum at 550° C. for 4 hrs to obtain the Li₆PS_{4.4}O_{0.6}Cl_{0.5}Br_{0.5} electrolyte.

The Li₆PS_{4.4}O_{0.6}Cl_{0.5}Br_{0.5} electrolyte has an argyrodite phase, and contains a Li₂S impurity phase.

The room-temperature ionic conductivity of the Li₆PS_{4.4}O_{0.6}Cl_{0.5}Br_{0.5} electrolyte was 4.2 mS/cm.

After the Li₆PS_{4.4}O_{0.6}Cl_{0.5}Br_{0.5} electrolyte was soaked in an anisole solvent at room temperature for 2 hrs and then dried, the room-temperature ionic conductivity of the Li₆PS_{4.4}O_{0.6}Cl_{0.5}Br_{0.5} electrolyte was 3.07 mS/cm.

After the Li₆PS_{4.4}O_{0.6}Cl_{0.5}Br_{0.5} electrolyte was exposed to the dew-point temperature of −40° C. in a drying room for 4 hrs, the room-temperature ionic conductivity of the Li₆PS_{4.4}O_{0.6}Cl_{0.5}Br_{0.5} electrolyte was 2.90 mS/cm.

To further study the stability of the prepared Li₆PS_{4.4}O_{0.6}Cl_{0.5}Br_{0.5} electrolyte against lithium electrodes to explore the feasibility of using lithium electrodes as negative poles, a constant-current charge-discharge test was carried out on a symmetric battery assembled from the electrolyte and metal lithium. The test current density for the LLi/Li₆PS_{4.4}O_{0.6}Cl/Li symmetric battery was 0.1 mA/cm², the single charge-discharge time was 1 h, and the test capacity density was 0.1 mAh/cm². Test results indicate that the Li/Li₆PS_{4.4}O_{0.6}Cl/Li symmetric battery can be recycled for 950 hrs under the current density of 0.1 mA/cm², and the polarization voltage is increased obviously, indicating that the Li₆PS_{4.4}O_{0.6}Cl_{0.5}Br_{0.5} electrolyte has poor stability against lithium.

### Comparative Example 3

An electrolyte in Comparative Example 3 has a molecular formula: Li₆PSe_{4.8}O_{0.2}Cl_{0.5}Br_{0.5}, and is obtained through the following preparation method:
(a) Li₂Se, P₂Se₅, P₂O₅, LiCl and LiBr were weighed according to a molar ratio, poured into an agate mortar, and then manually ground for 30 min to obtain an electrolyte precursor; and
(b) The electrolyte precursor was sintered in vacuum at 550° C. for 4 hrs to obtain the Li₆PSe_{4.8}O_{0.2}Cl_{0.5}Br_{0.5} electrolyte.

The Li₆PSe_{4.8}O_{0.2}Cl_{0.5}Br_{0.5} electrolyte has an argyrodite phase, and contains a Li₂Se impurity phase.

The room-temperature ionic conductivity of the Li₆PSe_{4.8}O_{0.2}Cl_{0.5}Br_{0.5} electrolyte was 1.7 mS/cm.

After the Li₆PSe_{4.8}O_{0.2}Cl_{0.5}Br_{0.5} electrolyte was soaked in an anisole solvent at room temperature for 2 hrs and then dried, the room-temperature ionic conductivity of the Li₆PSe_{4.8}O_{0.2}Cl_{0.5}Br_{0.5} electrolyte was 1.02 mS/cm.

After the Li₆PSe_{4.8}O_{0.2}Cl_{0.5}Br_{0.5} electrolyte was exposed to the dew-point temperature of −40° C. in a drying room for 4 hrs, the room-temperature ionic conductivity of the Li₆PSe_{4.8}O_{0.2}Cl_{0.5}Br_{0.5} electrolyte was 0.85 mS/cm.

To further study the stability of the prepared Li₆PSe_{4.8}O_{0.2}Cl_{0.5}Br_{0.5} electrolyte against lithium electrodes to explore the feasibility of using lithium electrodes as negative poles, a constant-current charge-discharge test was carried out on a symmetric battery assembled from the electrolyte and metal lithium. The test current density for the Li/Li₆PSe_{4.8}O_{0.2}Cl_{0.5}Br_{0.5}/Li symmetric battery was 0.1 mA/cm², the single charge-discharge time was 1 h, and the test capacity density was 0.1 mAh/cm². Test results indicate that the Li/Li₆PSe_{4.8}O_{0.2}Cl_{0.5}Br_{0.5}/Li symmetric battery can be cycled for 50 hrs at the current density of 0.1 mA/cm², and the polarization voltage is increased obviously, indicating that the Li₆PSe_{4.8}O_{0.2}Cl_{0.5}Br_{0.5} electrolyte has poor stability against lithium.

### Comparative Example 4

An electrolyte in Comparative Example 4 has a molecular formula: Li₆PS_{4.8}O_{0.2}Cl, and is obtained through the following preparation method:
(a) A lithium sulfide material was prepared by inter-reaction between lithium-containing and sulfur-containing substances: lithium and elemental sulfur were dissolved in diethyl ether respectively according to a mass ratio of 2.1:1, mixed, and then distillated under reduced pressure to obtain Li₂S;
(b) Li₂S, P₂S₅, P₂O₅ and LiCl were weighed according to a molar ratio, poured into an agate mortar, and then manually ground for 30 min to obtain an electrolyte precursor; and
(c) The electrolyte precursor was sintered in vacuum at 550° C. for 4 hrs to obtain the Li₆PS_{4.8}O_{0.2}Cl electrolyte.

The Li₆PS_{4.8}O_{0.2}Cl electrolyte has an argyrodite phase, and contains a Li₂S impurity phase.

The room-temperature ionic conductivity of the Li₆PS_{4.8}O_{0.2}Cl electrolyte was 9.8 mS/cm.

After the Li₆PS_{4.8}O_{0.2}Cl electrolyte was soaked in an anisole solvent at room temperature for 2 hrs and then dried, the room-temperature ionic conductivity of the Li₆PS_{4.8}O_{0.2}Cl electrolyte was 6.86 mS/cm.

After the Li₆PS_{4.8}O_{0.2}Cl electrolyte was exposed to the dew-point temperature of −40° C. in a drying room for 4 hrs, the room-temperature ionic conductivity of the Li₆PS_{4.8}O_{0.2}Cl electrolyte was 6.57 mS/cm.

To further study the stability of the prepared Li₆PS_{4.8}O_{0.2}Cl electrolyte against lithium electrodes to explore the feasibility of using lithium electrodes as negative poles, a constant-current charge-discharge test was carried out on a symmetric battery assembled from the electrolyte and metal lithium. The test current density for the Li/Li₆PS_{4.8}O_{0.2}Cl/Li symmetric battery was 0.1 mA/cm², the single charge-discharge time was 1 h, and the test capacity density was 0.1 mAh/cm². Test results indicate that the Li/Li₆PS_{4.8}O_{0.2}Cl/Li symmetric battery can be cycled for 1,000 hrs at the current density of 0.1 mA/cm², and the polarization voltage is increased obviously, indicating that the Li₆PS_{4.8}O_{0.2}Cl electrolyte has poor stability against lithium.

### Comparative Example 5

An electrolyte in Comparative Example 5 has a molecular formula: Li₆PS_{4.8}O_{0.2}Br, and is obtained through the following preparation method:
(a) A lithium sulfide material was prepared by inter-reaction between lithium-containing and sulfur-containing substances: lithium and elemental sulfur were dissolved in diethyl ether respectively according to a mass ratio of 2.1:1, mixed, and then distillated under reduced pressure to obtain Li₂S;
(b) Li₂S, P₂S₅, P₂O₅ and LiCl were weighed according to a molar ratio, poured into an agate mortar, and then manually ground for 30 min to obtain an electrolyte precursor; and
(c) The electrolyte precursor was sintered in vacuum at 550° C. for 4 hrs to obtain the Li₆PS_{4.8}O_{0.2}Br electrolyte.

The Li₆PS_{4.8}O_{0.2}Br electrolyte has an argyrodite phase, and contains a Li₂S impurity phase.

The room-temperature ionic conductivity of the Li₆PS_{4.8}O_{0.2}Br electrolyte was 1.1 mS/cm.

After the Li₆PS_{4.8}O_{0.2}Br electrolyte was soaked in an anisole solvent at room temperature for 2 hrs and then dried, the room-temperature ionic conductivity of the Li₆PS_{4.8}O_{0.2}Br electrolyte was 0.71 mS/cm.

After the Li₆PS_{4.8}O_{0.2}Br electrolyte was exposed to the dew-point temperature of −40° C. in a drying room for 4 hrs, the room-temperature ionic conductivity of the Li₆PS_{4.8}O_{0.2}Br electrolyte was 0.66 mS/cm.

To further study the stability of the prepared Li₆PS_{4.8}O_{0.2}Br electrolyte against lithium electrodes to explore the feasibility of using lithium electrodes as negative poles, a constant-current charge-discharge test was carried out on a symmetric battery assembled from the electrolyte and metal lithium. The test current density for the Li/Li₆PS_{4.8}O_{0.2}Br/Li symmetric battery was 0.1 mA/cm², the single charge-discharge time was 1 h, and the test capacity density was 0.1 mAh/cm². Test results indicate that the Li/Li₆PS_{4.8}O_{0.2}Br/Li symmetric battery can be cycled for 100 hrs at the current density of 0.1 mA/cm², and the polarization voltage is increased obviously, indicating that the Li₆PS_{4.8}O_{0.2}Br electrolyte has poor stability against lithium.

Finally, it should be noted that the specific embodiments described in this specification are merely used to describing the spirit of the invention by way of examples, and are not intended to limit the embodiments of the invention. Those skilled in the art can make various modifications, supplements or similar substitutions to the specific embodiments described here, and it is unnecessary and impossible to exhaust all possible embodiments of the invention. All obvious changes or transformations derived based on the essential spirit of the invention should fall within the protection scope of the invention, and it is against the spirit of the invention to interpret these changes or transformations as any additional limitations.

What is claimed is:

1. A high-purity argyrodite-phase sulfide solid electrolyte, being of molecular formula I:
Li₆₊ᵢP₁₋ₑEₑS_{5±i-g}G_{g}Cl_{1±i±t}Tₜ formula I;
in formula I, 0≤i<1, 0≤e<1, 0≤g<0.5, 0.2≤t<1, E is one or more of Ge, Si, Sn and Sb, G is compound of Se and O, or O, and T is Br and/or I;
the high-purity argyrodite-phase sulfide solid electrolyte has a pure phase.

2. The high-purity argyrodite-phase sulfide solid electrolyte according to claim 1, wherein a room-temperature ionic conductivity of the high-purity argyrodite-phase sulfide solid electrolyte is 1×10⁻³-8×10⁻² S/cm.

3. The high-purity argyrodite-phase sulfide solid electrolyte according to claim 1, wherein after being exposed to a dew-point temperature of −40° C. in a drying room for 4 hrs, the high-purity argyrodite-phase sulfide solid electrolyte has an ionic conductivity decreased by 15% or less.

4. The high-purity argyrodite-phase sulfide solid electrolyte according to claim 1, wherein after being soaked in an organic solvent at room temperature for 2 hrs, the high-purity argyrodite-phase sulfide solid electrolyte has an ionic conductivity decreased by 20% or less.

5. The high-purity argyrodite-phase sulfide solid electrolyte according to claim 4, wherein the organic solvent is one or more selected from the group consisting of ethylene carbonate, fluoroethylene carbonate, ethyl methyl carbonate, dimethyl carbonate, N-methylpyrrolidone, tetrahydrofuran, glycol dimethyl ether, anisole, 1,3-oxacyclopentane, methylbenzene, xylene, chlorobenzene, and n-heptane.

6. A preparation method of the high-purity argyrodite-phase sulfide solid electrolyte according to claim 1, comprising:
(a) preparing a lithium sulfide material;
(b) weighing raw materials comprising the lithium sulfide material and an oxidant according to a molar ratio, and mixing the raw materials; and
(c) performing annealing sintering on powder obtained in Step (b) to obtain the high-purity argyrodite-phase sulfide solid electrolyte.

7. The preparation method according to claim 6, wherein a method for preparing the lithium sulfide material comprises one or more of a ball-milling method, a carbothermic method, lithiation of a sulfur-containing chemical substance, sulfuration of lithium nano-particles, and inter-reaction between lithium-containing and sulfur-containing substances.

8. The preparation method according to claim 6, wherein the oxidant is one or more of Li₂O, P₂O₅, Li₃PO₄ and I₂.

9. The preparation method according to claim 6, wherein a method for mixing the raw material in Step (b) comprises one of more of manual grinding, mechanical stirring, mechanical oscillation, mechanical ball-milling, high-energy ball-milling, and roller-milling.

10. The preparation method according to claim 9, wherein in a case where the method for mixing the raw materials in Step (b) is the high-energy ball-milling or the roller-milling, a ball-material ratio is (1-60):1, the high-energy ball-milling or the roller-milling is carried out at a speed of 200-600 rpm for 4-24 hrs.

11. The preparation method according to claim 6, wherein in Step (c) the annealing sintering is performed at 400-600° C. for 1-48 hrs.

12. An all-solid-state battery, comprising a positive pole, a negative pole, and the high-purity argyrodite-phase sulfide solid electrolyte according to claim 1.
